(19) United States
(12) Patent Application Publication
(10) Pub. No.: US 2016/0258687 A1
(43) Pub. Date: Sep. 8, 2016

(54) DUCTING FOR MANUFACTURE OF IRON

(71) Applicant: NOVA Chemicals (International) S.A., Fribourg (CH)

(72) Inventors: Vasily Simanzhenkov, Calgary (CA); Michel Berghmans, Calgary (CA); Hany Iskandar Farag, Calgary (CA)

(73) Assignee: NOVA Chemicals (International) S.A., Fribourg (CH)

(21) Appl. No.: 15/042,550

(22) Filed: Feb. 12, 2016

(30) Foreign Application Priority Data
Mar. 4, 2015 (CA) 2883863

(51) Int. Cl. F27D 7/02; C21B 13/00

(52) U.S. Cl. CPC F27D 7/02; C21B 13/0033; F27D 2007/023

(57) ABSTRACT

In the reduction of iron oxides to iron at temperatures greater than about 700° C. the propensity for the formation of coke in the duct work between furnaces is reduced by using steel having a surface comprising a spinel of the formula MnₓCr₃₋ₓO₄ wherein x is from 0.5 to 2.

The present invention relates to improved duct work for the production of iron, for example, molten iron using a fluidized bed reduction process. More particularly the present invention relates to use of high temperature high chromium high nickel steels having an internal surface comprising from 40 to 60 weight % of compounds of the formula MnₓCr₃₋ₓO₄ wherein x is from 0.5 to 2 and from 60 to 40 weight % of oxides of Mn and Si selected from MnO, MnSiO₃, Mn₂SiO₄ and mixtures thereof provided that the surface contains less than 5 weight % of Cr₂O₃.

The iron and steel industry supplies the basic materials needed in construction and in the manufacture of automobiles, ships, home appliances, and many of the other products. In an iron foundry, molten iron, which is pig iron in a molten state, is produced by using iron ore and coal as raw materials. Steel is produced from the molten iron and then supplied to customers.

At present, approximately 60% of the world's iron production is made using the blast furnace process developed from the 14th century. In the blast furnace process, coke produced from bituminous coal and iron ore that have undergone a sintering process are charged into a blast furnace, and hot gas is supplied to the blast furnace to reduce the iron ore to iron, producing molten iron. However, in the blast furnace process, environmental issues are a concern.

A smelting reduction process has been developed in which molten iron is manufactured in a melter-gasifier by directly using raw coal, as a fuel and a reducing agent, and iron ore as an iron source. Oxygen is injected through a plurality of tuyeres installed in an outer wall of the melter-gasifier, a coal-packed bed in the melter-gasifier is burned, to produce molten iron. The oxygen is converted into a hot reducing gas and is transferred to one or more fluidized-bed reduction reactor(s). Then, the hot reducing gas reduces iron ore having a fine particle size and is discharged.

There are a number of patents that describe this type of process including U.S. Pat. No. 6,224,819 issued May 1, 2001 to Kim et al., U.S. Pat. No. 6,585,798 issued Jul. 1, 2003 to Choi et al., and U.S. Pat. No. 7,850,902 issued Dec. 14, 2010 to Jeong et al.

The fluidized bed reduction reactor(s) are operated at temperature from about 800° C. to about 900° C. The oxygen containing gas generally comprises a large amount of CO. Under these conditions there is a propensity for coke formation in the duct work transferring hot oxygen reducing gases to a fluidized bed reduction reactor or between fluidized bed reduction reactors. If coke builds up in the ducting or transfer lines for fluidized bed reduction reactors there is an increased pressure drop across the line requiring cleaning and potentially shutting down the reactor or isolating the line.

In some embodiments, the present invention seeks to provide ductwork for use in a fluidized bed reduction reactor that has a low propensity for coking.

In one embodiment, the present invention provides the improvement in an apparatus for the production of molten (pig) iron in which hot reducing gas from the top of a blast furnace or a fluidized bed iron ore reduction reactor is cleaned of residual particulate matter and transferred through a transfer line to an upstream fluidized bed iron ore reduction reactor or pre-heater, comprising forming the transfer line from a metal selected from the group consisting of carbon steel, stainless steel, heat resistant steel, HP, HT, HU, HW and HX stainless steel, and nickel or cobalt based HTA alloys (from U.S. Pat. No. 6,899,966) having on its internal surface a coating having a thickness from 10 to 5,000 microns comprising from 40 to 60 weight % of compounds of the formula MnₓCr₃₋ₓO₄ wherein x is from 0.5 to 2 and from 60 to 40 weight % of oxides of Mn and Si selected from MnO, MnSiO₃, Mn₂SiO₄ and mixtures thereof provided that the surface contains less than 5 weight % of Cr₂O₃.

A further embodiment provides the apparatus as above wherein the hot reducing gas from the top of a blast furnace or a fluidized bed iron ore reduction reactor is cleaned of residual particulate matter using one or more separators selected from a cyclone (cyclones may remove particles to sized down to about 5 μm Handbook of Separation Techniques for Chemical Engineers Second edition Philip A. Schweitzer Editor in Chief McGraw Hill Book Company 1988 pages 6-10 & 6-11) and a magnetic filter (particularly see USH 2238 for aerosol dispersions).

A further embodiment provides the apparatus as above wherein not less than 85% of the inner surface of the transfer line is covered with said coating.

A further embodiment provides the apparatus as above wherein said coating has a thickness from 10 to 1,000 microns.

A further embodiment provides the apparatus as above wherein in said coating Cr₂O₃ is present in an amount of less than 2 weight %.

A further embodiment provides the apparatus as above wherein the transfer line comprises from 13 to 50 weight % of Cr and from 20 to 50 weight % of Ni.

A further embodiment provides the apparatus as above wherein the transfer line comprises from 50 to 70 weight % of Ni; from 20 to 10 weight % of Cr; from 20 to 10 weight % of Co; and from 5 to 9 weight % of Fe.

A further embodiment provides the apparatus as above wherein the transfer line comprises from 40 to 65 weight % of Co; from 15 to 20 weight % of Cr; and from 20 to 13 weight % of Ni; less than 4 weight % of Fe; and up to 20 weight % of W.

A further embodiment provides the apparatus as above wherein the oxide is MnO.

A further embodiment provides the apparatus as above wherein the oxide is MnSiO₃.

A further embodiment provides the apparatus as above wherein the oxide is Mn₂SiO₄.

A further embodiment provides the apparatus as above wherein the oxide is a mixture of MnO, MnSiO₃ and Mn₂SiO₄.

In a further embodiment, the improvement in a process to reduce fine iron ores to sponge iron at a temperature from 700° C. to 900° C., for example, 800° C. to 900° C. and a pressure from 2 to 5 barg in the presence of a reducing gas in a series of two or more fluidized bed reactors wherein a reducing gas is passed from an upstream fluidized bed reactor to a downstream fluidized bed reactor; the improvement comprising removing particulate iron ore from the reducing gas prior to transfer to an upstream fluidized bed reactor and constructing the conduit for transferring said reducing gas relatively free of particulate iron ore of a metal selected from carbon steel, stainless steel, heat resistant steel, HP, HT, HU, HW and HX stainless steel, and nickel or cobalt based HTA alloys (from U.S. Pat. No. 6,899,966) said conduit having on its internal surface a coating having a thickness from 10 to 5,000 microns comprising from 40 to 60 weight % of compounds of the formula MnₓCr₃₋ₓO₄ wherein x is from 0.5 to 2 and from 60 to 40 weight % of oxides of Mn and Si selected from of MnO, MnSiO₃, Mn₂SiO₄ and mixtures thereof provided that the surface contains less than 5 weight % of Cr₂O₃.

A further embodiment provides the improvement in the above process wherein, the reducing gas comprises:

from 50 to 70 mole % of CO, from 30 to 15 mole % of H₂, from 10 to 5 mole % of CO₂, and from 0 to 10 mole % of N₂ the sum of said components adding up to 100 mole %.

A further embodiment provides the improvement in the above process wherein the fine iron particles comprise at least 50 wt % of one or more members selected from Fe, FeO, Fe₂O₃, and Fe₃O₄.

### BRIEF DESCRIPTION OF THE DRAWING

FIG. 1 is a schematic view of a smelting reduction apparatus including a three-stage fluidized bed reduction reactor according to one preferred embodiment of the present invention.

Other than in the operating examples or where otherwise indicated, all numbers or expressions referring to quantities of ingredients, reaction conditions, etc. used in the specification and claims are to be understood as modified in all instances by the term “about.” Accordingly, unless indicated to the contrary, the numerical parameters set forth in the following specification and attached claims are approximations that can vary depending upon the properties that the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

All compositional ranges expressed herein are limited in total to and do not exceed 100 percent (volume percent or weight percent) in practice. Where multiple components can be present in a composition, the sum of the maximum amounts of each component can exceed 100 percent, with the understanding that, and as those skilled in the art readily understand, that the amounts of the components actually used will conform to the maximum of 100 percent.

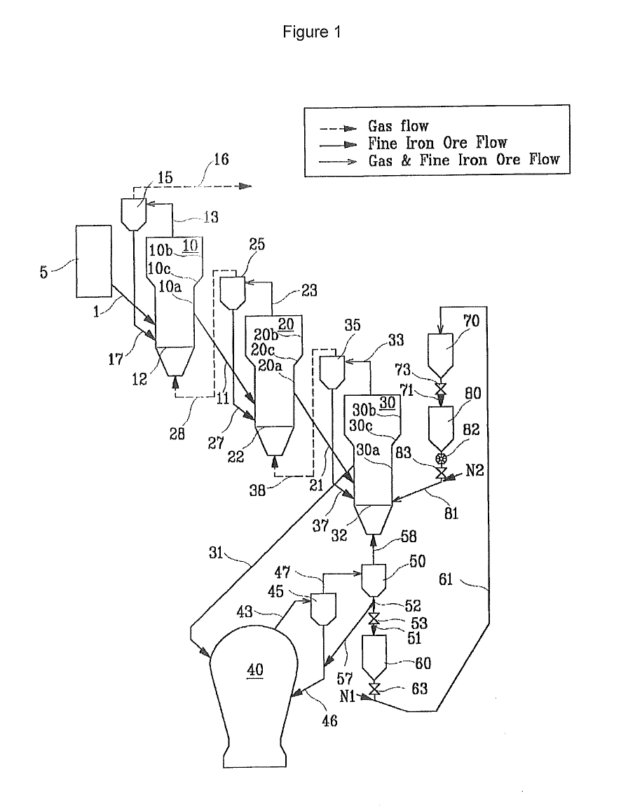

The general operation of a smelting reduction apparatus including a series of fluidized bed reduction reactors will be described in accordance with FIG. 1.

The three-stage type fluidized bed reactors include a pre-heating furnace 10, a pre-reducing furnace 20, and a final reducing furnace 30.

In one embodiment, the pre-heating furnace 10 is mounted with an ore charging duct 1 on a side wall for charging fine iron ores which gravity feed from a charging bin 5, a gas supply duct 28 at a lower part of furnace 10 supplies reducing gas discharged from the pre-reducing furnace 20, and a first cyclone 15. The first cyclone 15 collects fine particles of ores which are included in the exhaust gas discharged via a gas discharging duct 13 and feeds the fine ore particles to the lower part of the pre-heating furnace 10 via line 17. The exhaust gas from which the fine ore particles are removed is released via a discharge duct 16, which is mounted at an upper part of the cyclone 15.

In one embodiment, the fine iron ore typically has a particle distribution from about 0.25 to about 8 mm. Most of the particles, about 50 to 60 wt. % have a size from about 1 to 8 mm, in some embodiments from about 1 to 5 mm. About 25 to 30 wt. % of the particles have a size from 0.25 mm to 1 mm. The balance of the particles have a size less than about 0.25 mm.

In one embodiment, the very fine dust which leaves the cyclone by the bottom exit may have a particle size from about 150 to about 2,000 microns (0.125 mm to about 2 mm).

In another embodiment, the iron particles entrained in the overhead line leaving the cyclone have a particle size from about 25 to about 150 microns.

In one embodiment, the pre-reducing furnace 20 is mounted with an ore feed duct 11 on a side wall for supplying the fine iron ores which are preheated in the pre-heating furnace 10, a gas supply duct 38 at a lower part for supply reducing gas which is discharged from the final reducing furnace 30, and a second cyclone 25. In one embodiment, the second cyclone 25 collects fine particles of ores which are included in the exhaust gas discharged via a gas discharging duct 23 and feeds the fine ore particles to a lower part of the pre-reducing furnace 20. The exhaust gas from which the fine ore particles are removed is supplied to the lower part of the pre-heating furnace 10 via a gas supply duct 28 which is mounted at an upper part of the cyclone 25.

In one embodiment, the final reducing furnace 30 is mounted with an ore feed duct 21 on a side wall for supplying the fine iron ores which are pre-reduced in the pre-reducing furnace 20, a gas supply duct 58 at a lower part for supply reducing gas which is discharged from the melter-gasifier 40, and a third cyclone 35. The third cyclone 35 collects fine particles of ores which are included in the exhaust gas discharged via a gas discharging duct 33 and feeds the fine ore particles to a lower part of the final reducing furnace 30. The exhaust gas from which the fine ore particles are removed is supplied to the lower part of the pre-reducing furnace 20 via a gas supply duct 38 which is mounted at an upper part of the cyclone 35.

In one embodiment, the pre-heating furnace 10, the pre-reducing reactor 20 and the final reducing reactor 30 have a small diameter in the lower parts 10a, 20a, and 30a, a large diameter in the upper parts 10b, 20b, and 30b, and the slantingly formed cylindrical connection parts 10c, 20c, and 30c so that iron ore particles disengaged from the gas flow will flow/fall back into the lower cylindrical parts 10a, 20a, and 30a, respectively. The whole shape of the respective fluidized bed reactors is formed in the dual-stage cylinder having the narrow lower parts and the wide upper parts.

In one embodiment, the diameter of the upper parts 10b, 20b and 30b of the respective fluidized bed reactors ranges from 1.5 to about 2.0 times of the diameter of the lower parts 10a, 20a and 30a, so that the velocity of the gas in the upper parts of the respective fluidized bed reactors is decreased to provide a particle disengagement zone to reduce the amount of fine iron ores from being carried into cyclones 15, 25, and 35 respectively.

In one embodiment, the height of the fluidized bed reactors is, for example, from 10 to about 20 times of the diameter of the lower parts 10a, 20a and 30a. The height of the cylindrical lower parts 10a, 20a and 30a is, for example, from 1.0 to about 1.5 times of height of the cylindrical upper parts 10b, 20b and 30b, and the inclination of the connecting parts 10c, 20c and 30c is, in one embodiment, inclined by 20 to about 30 relative to the central axes of the respective fluidized bed reactors.

In one embodiment, the fine iron ores which are preliminarily reduced in the final reducing furnace 30 of the three-stage type fluidized bed reactors as above, are supplied to the upper part of the melter-gasifier 40 which will be described hereinafter via an ore discharging duct 31. The exhaust gas, which is discharged from the melter-gasifier 40, is, however, not directly supplied to the final reducing furnace 30 but via the dust separation device, which will be described hereinafter.

In one embodiment, the dust separation device according to the present invention is mounted between the melter-gasifier 40 and the final reducing furnace 30 and includes two cyclones and three dust storage bins which are disposed in series.

Now, the dust separation device will be described in more detail.

In a first embodiment, a fourth cyclone 45, which is a first element of the dust separation device, is connected to the melter-gasifier 40, through an exhaust gas discharging duct 43 and a first dust supply duct 46. The fourth cyclone 45 is supplied with high temperature exhaust gas from the melter-gasifier 40 via the exhaust gas discharging duct 43 and primarily separates dust which are entrained in the exhaust gas. The dust collected by the fourth cyclone 45 is returned to the melter-gasifier 40 via the first dust supply duct 46. Reducing gas from which the dust is primarily removed in the fourth cyclone 45 is supplied to a fifth cyclone 50 which will be described hereinafter via an exhaust gas discharging duct 47 which is mounted at an upper part of the fourth cyclone 45.

In another embodiment, the fifth cyclone 50 separates and collects dust of an ultrafine particle size which is included in the reducing gas which is supplied from the fourth cyclone 45 but not separated by the fourth cyclone 45. The ultrafine dust collected by the fifth cyclone 50 is supplied to a first dust storage bin 60 via a second dust supply duct 51 which is connected to a lower part of the fifth cyclone 50, wherein the second dust supply duct 51 is mounted with a two-way valve 52 so that the dusts collected in the fifth cyclone 50 are partially re-supplied to the melter-gasifier 40 via a third dust supply duct 57 as necessary. The third dust supply duct 57 may be directly connected to the melter-gasifier 40 and is, for example, connected to the first dust supply duct 46.

In one embodiment, the fifth cyclone 50 is connected to a reducing gas discharge duct 58 at an upper part to supply the reducing gas from which the dust is removed to the final reducing furnace 30.

In one embodiment, the first dust storage bin 60 is provided with a first nitrogen injection device N1 at a lower part for conveying the stored ultrafine dust to a second dust storage bin 70. The first dust storage bin 60 is connected to the dust storage bin 70 via a dust conveying duct 61.

In one embodiment, the second dust storage bin 70 is connected to a third dust storage bin 80 via a fourth dust supply duct 71, so that the ultrafine dust collected in the second dust storage bin 70 is supplied to the third dust storage bin 80 via the fourth dust supply duct 71.

In one embodiment, a lower part of the third dust storage bin 80 is connected above and proximate to a gas distributor 32 of the final reducing furnace 30 via a fifth dust supply duct 81. The fifth dust supply duct 81 is mounted with a dust charging feeder 82 at its upper end to control the amount of dust which is supplied to the final reducing furnace 30. The dust charging feeder duct 82 is provided with a second nitrogen-injection device N2 at a lower end for feeding the ultrafine dust to the final reducing furnace 30 at relatively high pressure. Accordingly, the ultrafine dust which is injected above and proximate to the gas distributor 32 of the final reducing furnace 30 is coated on surfaces of the fine iron ore particles (larger than the size of the ultrafine dust) in the final reducing furnace 30.

In one embodiment, the dust separation device of the present invention as described above is mounted with control valves 53, 63, 73, and 83 on the respective dust supply ducts for stopping the flow of the dusts and gas in case of operating or repairing the device, if it is necessary.

The method for manufacturing the molten pig iron by melting the fine iron ores of a wide particle size distribution by using the smelting reduction apparatus of the present invention will now be described in more detail.

In a first embodiment, the fine iron ore gravity fed from charging bin 5 is supplied to a side of the pre-heating furnace 10 via an ore charging duct 1, the fine particles of iron ore (dust) which are collected in the first cyclone 15 are returned to a side of the pre-heating furnace 10 via a first circulation duct 17, and the high temperature reducing gas which is discharged from the pre-reducing furnace 20 is supplied to a lower part of the pre-heating furnace 10, below distributor 12, via the gas supply duct 28. The fine iron ore and the fine particles of iron ore (dust), supplied to the pre-heating furnace 10, are preheated by the reducing gas in the pre-heating furnace 10, forming a bubbling fluidized bed.

In one embodiment, the pre-reducing furnace 20 is supplied with the fine iron ore preheated in the pre-heating furnace 10 via an ore charging duct 11 to a side of pre-reducing furnace 20, as well as the fine iron ores particles (dust), which are collected in the second cyclone 25, via a second circulation duct 27 to pre-reducing furnace 20. Further, the pre-reducing furnace 20 is supplied with the high temperature reducing gas discharged from the final reducing furnace 30 to its lower end below distribution 22 via a gas supply duct 38. The fine iron ore and the fine particles of iron ore (dust), which are supplied to the pre-reducing furnace 20, are pre-reduced by the reducing gas in the pre-reducing furnace 20, forming a bubbling fluidized bed.

In one embodiment, the final reducing furnace 30 is supplied with the fine iron ores pre-reduced by the pre-reducing furnace 20 via an ore charging duct 21 to a side, as well as the particles of fine iron ore (dust), which are collected in the third cyclone 35, via a third circulation duct 37 to a side of final reducing furnace 30. Further, the final reducing furnace 30 is supplied with the high temperature reducing gas discharged from the fourth cyclone 50 to its lower part below distribution 32 via gas supply duct 58. The fine iron ore and the fine particles of iron ore (dust) which are supplied to the final reducing furnace 30 are finally preliminarily reduced by the reducing gas in the final reducing furnace 30, forming a bubbling fluidized bed.

As above, fine particle sponge iron, which is sequentially preliminarily reduced while passing through the three-stage type fluidized bed reactor, are charged into the upper part of the melter-gasifier 40 via the ore discharge duct 31. The melter-gasifier 40 is supplied with coal and high pressure oxygen in addition to the sponge iron which is supplied from the final reducing reactor 30 so as to finally reduce and melt the sponge iron, producing molten pig iron.

In another embodiment, the melter-gasifier 40 generates a lot of exhaust gas of high temperature in the process of melting the sponge iron.

In one embodiment, the exhaust gas from melter-gasifier 40 comprises ultrafine dust which contains a lot of carbon and carbonized gas generated in the process of the burning of the charged coal. The dust containing carbon and carbonized gas are sequentially separated by the dust separation device of the present invention. Now, the process for separating the exhaust gas will be described in more detail.

In another embodiment, the exhaust gas, which is discharged from the melter-gasifier 40, is supplied to the fourth cyclone 45 via the discharge duct 43. The exhaust gas supplied to the cyclone is separated into particulate dust and carbonized gas in the gas state by a strong centrifugal force, wherein the separated dusts fall down to a lower part in the cyclone and the carbonized gas is gathered in an upper part in the cyclone. The separated dusts collected to the lower part are re-supplied to the melter-gasifier 40 via the first dust supply duct 46, while the separated carbonized gas is discharged to the fifth cyclone 50, containing any residual ultrafine dust which is not separated.

In one embodiment, the fifth cyclone 50 secondarily collects the ultrafine dust entrained in the carbonized gas feed. The carbonized gas from which the ultrafine dust has been separated is supplied to the final reducing furnace 30 to be used as the reducing gas. The ultrafine dusts collected in fifth cyclone 50 are returned to the melter-gasifier 40 or the first dust storage bin 60.

In one embodiment, the dust discharged to the first dust storage bin 60 is conveyed to the second dust storage bin 70 by the first nitrogen injection device N1 and continuously supplied to the third dust storage bin 80.

In one embodiment, the dust stored in the third dust storage bin 80 is injected above and proximate to gas distributor 32 of the final reducing furnace 30 by the second nitrogen injection device N2 and coat the fine iron ore particles which are in bubbling fluidization state in the final reducing furnace 30.

In one embodiment, the pressure of the nitrogen supplied by the first and second nitrogen injection devices N1 and N2 is higher than the pressure in the furnace typically by about 1.5 to 3.5, generally about 2 to 3 times. The dust is smoothly conveyed and stabled injected in the final reducing furnace 30 by the higher pressure nitrogen.

In one embodiment, the amount of the dust which is introduced into the final reducing furnace 30 is, in one embodiment, controlled to be 0.5.about.1.0 wt % with relation to an amount of raw iron ore which is charged into the pre-heating furnace 10. If the amount of the dust which is introduced into the final reducing furnace 30 is less than 0.5 wt % based on the amount of raw iron ore fed to pre-heating furnace 10, the effectiveness of the dust to prevent sticking and agglomeration of the fine iron ores is reduced, while if the amount exceeds 1.0 wt %, upstream the gas distributor(s) (e.g., 22 and 12) may be clogged by carry over ultrafine dust.

In one embodiment, it may be preferable to control a velocity of the reducing gas in the pre-heating furnace 10, the pre-reducing furnace 20 and the final reducing furnace 30 in the range of 1.2 to about.1.5 times of a minimum fluidizing velocity of the fine iron ores which stay in the furnaces. By maintaining the velocity of the reducing gas as above, the respective fluidized bed reactors form a stable bubbling fluidized bed.

As noted above, in one embodiment, the reducing gas from the melter-gasifier 40 comprises carbonized components. The gas has a composition comprising from 60 to 70 mole % CO; from 20 to 30 mole % H₂; from about 3 to 8 mole % of CO₂; and from about 3 to 8 mole % of N₂. In some embodiments, the gas comprises from 63 to 67 mole % of CO; from 23 to 27 mole % of H₂, from 3 to 7 mole % of CO₂ and from 3 to 7 mole % of N₂. As the gas passes through the various reactors, the amount of CO and H₂ may be reduced with an increasing amount of CO₂ and H₂O. Depending on the temperature, the carbon monoxide may be regenerated by the reduction of the iron.

In other embodiments, there may be a single meltier-gasifier in which exhaust gases are recycled to below the distributor (e.g., a direct reduction of iron process DRI).

Even in a convention blast furnace exhaust gases may be recaptured and burned to preheat the air/oxygen being fed to the furnace.

As noted above, in one embodiment, the reducing gas comprises CO which may under the conditions in the duct work form coke resulting from interaction with the surface of the steel duct work and in some instances heat exchangers/heaters for the oxygen containing gas. This results in a reduced efficiency for the flow of the gas through the duct work.

In one embodiment, typical temperatures for the reduction process range from about 700° C. to about 1000° C., for example, from about 750° C. to about 950° C., or for example, from about 800° C. to about 900° C.

In one embodiment, the duct work may be carbon steel or stainless steel which may be selected from wrought stainless, austentic stainless steel and HP, HT, HU, HW and HX stainless steel, heat resistant steel, and nickel based alloys. The steel may be a high strength low alloy steel (HSLA); high strength structural steel or ultra-high strength steel. The classification and composition of such steels are known to those skilled in the art.

In one embodiment, the stainless steel for the duct work, for example, heat resistant stainless steel typically comprises from 13 to 50, or for example, 20 to 50, or for example, from 20 to 38 weight % of chromium. The stainless steel may further comprise from 20 to 50, or for example, from 25 to 50, or for example, from 25 to 48, or for example, from about 30 to 45 weight % of Ni. The balance of the stainless steel is substantially iron.

In a further embodiment, the steel for the duct work may be a nickel and/or cobalt based extreme austentic high temperature alloys (HTAs). Typically, the alloys comprise a major amount of nickel or cobalt. Typically, the high temperature nickel based alloys comprise from about 50 to 70, or for example, from about 55 to 65 weight % of Ni; from about 20 to 10 weight % of Cr; from about 20 to 10 weight % of Co; and from about 5 to 9 weight % of Fe and the balance one or more of the trace elements noted below to bring the composition up to 100 weight %. Typically, the high temperature cobalt based alloys comprise from 40 to 65 weight % of Co; from 15 to 20 weight % of Cr; from 20 to 13 weight % of Ni; less than 4 weight % of Fe and the balance one or more trace elements as set out below and up to 20 weight % of W. The sum of the components adding up to 100 weight %.

In some embodiments, the steel may further comprise at least 0.2 weight %, or for example, up to 3 weight %, or for example, 1.0 weight %, or for example, up to 2.5 weight %, or for example, not more than 2 weight % of manganese; from 0.3 to 2, or for example, 0.8 to 1.6, or for example, less than 1.9 weight % of Si; less than 3, or for example, less than 2 weight % of titanium, niobium (for example, 2.0, or for example, less than 1.5 weight % of niobium) and all other trace metals; and carbon in an amount of less than 2.0 weight %.

In one embodiment, the internal surface of the duct may have a surface coating comprising a spinel has the formula MnₓCr₃₋ₓO₄ wherein x is from 0.5 to 2. In some embodiments, x may be from 0.8 to 1.2. In further embodiments, X is 1 and the spinel has the formula MnCr₂O₄.

In some embodiments, the outermost spinel surface of the stainless steel has a thickness from 0.1 to 25 microns thick. Generally, this outermost spinet surface covers not less than 55%, or for example, not less than 60%, or for example, not less than 80%, or for example, not less than 95% of the stainless steel. In other embodiments, the outermost spinel surface has a thickness from 0.1 to 15 microns thick. In further embodiments, the outermost spinel surface has a thickness for 0.1 to 10 microns thick.

One method of producing the surface of the present invention is by treating the shaped stainless steel (i.e., the duct). The stainless steel is treated in the presence of an atmosphere having an oxygen partial pressure less than 10⁻¹⁸ atmospheres comprising: i) increasing the temperature of the stainless steel from ambient temperature at a rate of 20° C. to 100° C. per hour until the stainless steel is at a temperature from 550° C. to 750° C.; ii) holding the stainless steel at a temperature from 550° C. to 750° C. for from 2 to 40 hours; iii) increasing the temperature of the stainless steel at a rate of 20° C. to 100° C. per hour until the stainless steel is at a temperature from 800° C. to 1100° C.; and iv) holding the stainless steel at a temperature from 800° C. to 1100° C. for from 5 to 50 hours.

In one embodiment, the heat treatment may be characterized as a heat/soak-heat/soak process. The stainless steel part is heated at a specified rate to a hold or “soak” temperature for a specified period of time and then heated at a specified rate to a final soak temperature for a specified period of time.

In one embodiment, the process the heating rate in steps (i) and (ii) may be from 20° C. to 100° C. per hour, or for example, 60° C. to 100° C. per hour. The first “soak” treatment is at a temperature 550° C. to 750° C. for from 2 to 40 hours, or for example, at a temperature from 600° C. to 700° C. for from 4 to 10 hours. The second “soak” treatment is at a temperature from 800° C. to 1100° C. for from 5 to 50 hours, or for example, at a temperature from 800° C. to 1000° C. for from 20 to 40 hours.

In one embodiment, the atmosphere for the treatment of the steel should be a very low oxidizing atmosphere. Such an atmosphere generally has an oxygen partial pressure of 10⁻¹⁸ atmospheres, or for example, 10⁻²⁰ atmospheres or less. In one embodiment, the atmosphere may consist essentially of 0.5 to 1.5 weight % of steam, from 10 to 99.5, or for example, from 10 to 25 weight % of one or more gases selected from of hydrogen, CO and CO₂ and from 0 to 89.5, or for example, from 73.5 to 89.5 weight % of an inert gas. The inert gas may be selected from of nitrogen, argon and helium. Other atmospheres which provide a low oxidizing environment will be apparent to those skilled in the art.

Other methods for providing the surface of the present invention will be apparent to those skilled in the art. For example, the stainless steel could be treated with an appropriate coating process for example as disclosed in U.S. Pat. No. 3,864,093 issued Feb. 4, 1975 to Wolfla assigned to Union Carbide.

It is known that there tends to be a scale layer intermediate the surface of a treated stainless steel and the matrix. For example this is briefly discussed in U.S. Pat. No. 5,536,338 issued Jul. 16, 1996 to Metivier assigned to ASCOMETAL S.A. Without wishing to be bound by theory, it is believed that there may be one or more scale layer(s) intermediate the outermost surface of the duct and the stainless steel matrix. Also, without being bound by theory, it is believed that one of these layers may be rich in chromium oxides; most likely chromia.

In an alternate embodiment, the surface and the compositions used to prepare the surface comprise from 90 to 10 weight %, of the above spinel (e.g., MnₓCr₃₋ₓO₄ wherein x is from 0.5 to 2) and from 10 to 90 weight % of oxides of Mn, Si selected from of MnO, MnSiO₃, Mn₂SiO₄ and mixtures thereof.

In a further embodiment, the surface and the compositions used to prepare the surface comprise from 60 to 40 weight %, of the above spinel (e.g., MnₓCr₃₋ₓO₄ wherein x is from 0.5 to 2) and from 40 to 60 weight % of oxides of Mn, Si selected from of MnO, MnSiO₃, Mn₂SiO₄ and mixtures thereof.

In a further embodiment, the surface and the compositions used to prepare the surface comprise from 45 to 55 weight %, of the above spinel (e.g., MnₓCr₃₋ₓO₄ wherein x is from 0.5 to 2) and from 55 to 45 weight % of oxides of Mn, Si selected from of MnO, MnSiO₃, Mn₂SiO₄ and mixtures thereof.

If the oxide has a nominal stoichiometry of MnO, the Mn may be present in the surface in an amount from 1 to 50 atomic %. Where the oxide is MnSiO₃, the Si may be present in the surface in an amount from 1 to 50 atomic %. If the oxide is Mn₂SiO₄, the Si may be present in the surface in an amount from 1 to 50 atomic %.

The surface and the compositions used to prepare the surface should comprise less than 5, or for example, less than 2, or for example, less than 0.5 weight % of Cr₂O₃. In one embodiment, Cr₂O₃ is absent in the surface or the compositions used to prepare the surface.

In some embodiments, the surface has a thickness from about 10 to 5,000 microns, typically, from 10 to 2,000, in further embodiments, from 10 to 1,000; in further embodiments, from 10 to 500 microns. Typically, the composite oxide surface covers at least about 70%; in other embodiments, at least about 85%; in other embodiments, not less than 95%; and in other embodiments not less than 98.5% of the surface of the stainless steel substrate.

It is known that the above oxide surfaces may be harmed by particulate iron oxides. As noted above, cyclones are used to remove a substantial amount of particulate iron entrained in the exhaust gases from one or more of the melt-gasifier, one or more reducing furnaces, a blast furnace or a furnace used in the DRI mode.

To further reduce or substantially eliminate the potential for carryover particulate iron oxides in the exhausts from one or more of the above devices, a further filtering means is used proximate to and downstream from the overhead exhaust from the cyclone used with the device.

In some embodiments, particle isolation systems in flow-fields are mechanically based. Such systems involve inserting fiber based material into the flow so as to capture particulates via collision and generally inducing a pressure drop. This adds additional cost to the operation of the plant.

In some embodiments, particle isolation systems in flow-fields are electrostatically based. This involves either maintaining a voltage difference across the flow or the insertion of a charge conductor into a flow so as to separate out the charged particles via a static electric field. A power supply is needed, thereby imposing equipment and/or operational cost.

However, a magnetic separator, does not inhibit fluid or gas flow and thus has no power requirements if permanent magnets are utilized.

In some embodiments, the filter is a magnetic filter, to catch the particulate metal. The magnets may be permanent. In lieu of permanent magnets, electromagnets could also be used that require very low power supplies (e.g., batteries). This would allow for stronger magnetic fields but diminish the energy advantage somewhat. However, the cost would be minimal because magnetic fields are directly proportional to current which allows a low resistance wire to be used in conjunction with a small power supply to produce very large magnetic fields. In some embodiments, at least two electromagnets are used in series so that one may be “turned off” while the other is on to permit collected iron particles to be removed from the magnet. In other embodiments, the magnetic filter may comprise an ejector of the collected particles.

In one embodiment, small dust particles entrained in the gas leaving the top of the cyclone become charged due to collisions with other particles and neighboring molecules.

Generally, a magnetic field is applied transverse to the flow of gas leaving the cyclone. Typically, a north (N) and a south (S) pole are applied to opposite sides of the exhaust line creating a magnetic field that perpendicularly traverses the direction of the flow. Positively and negatively charged particles are deflected in opposite directions in the magnetic field.

In some embodiments, there are entrainment zones associated with the magnetic field so that charged particles enter the entrainment zone which may be then swept with a purge gas to remove the particles.

A more detailed description of the use of magnetic separators for use with flowing gaseous fluids is set out in U.S. H2238 H published May 4, 2010 and the references cited therein.

The present invention is illustrated by the following non limiting examples.

### EXAMPLES

### Example 1

A Thermo-Gravimetric Reactor Unit (TGRU an aluminum lined reactor furnace tube as illustrated in FIG. 1 of U.S. Pat. No. 7,056,399 issued Jun. 6, 2006) was used to test the coking propensity of a metal coupon comprising austenitic stainless steel comprising about 33 wt % Cr, 1 wt % Mn, about 43 wt % Ni and the balance iron and trace elements having a surface or a coating having a thickness from 10 to 5,000 microns comprising from 40 to 60 weight % of compounds of the formula MnₓCr₃₋ₓO₄ wherein x is from 0.5 to 2 and from 60 to 40 weight % of oxides of Mn and Si selected from of MnO, MnSiO₃, Mn₂SiO₄ and mixtures thereof provided that the surface contains less than 5 weight % of Cr₂O₃ (spinel surface). The reactor comprises a microbalance on which hang the metal coupon to be tested. The metal coupon is enclosed in a furnace where the temperature can be raised up to 1150° C. in the presence of various atmospheres. First, the furnace in purged with nitrogen as the temperature is increased at a rate of 20° C./min. When the furnace temperature reaches 200° C., water is supplied to the furnace though a micro-syringe at a rate of 0.006 ml/min. When the furnace reaches 1000° C., the nitrogen flow is switched off and ethane at a rate of 15 sccm is turned on. As the ethane starts to flow to the reactor it is cracked generating mainly ethylene, hydrogen, and other compounds including coke that deposits on the metal surface of the coupon. The micro-balance records the metal coupon weight increase due to the coke deposition. After an hour, the ethane is turned off, and the furnace is purged with nitrogen. The nitrogen is turned off and air is turned on. As the air flows to the reactor, the deposited coke is gasifying, bringing the metal coupon's weight to its original value. The coking rate on the spinel surface was 27.391 mg/cm²h.

### Example 2

In a different experiment where the furnace of the TGRU was kept at 900° C., the coking rate on the spinel surface was 5.084 mg/cm²h.

### Example 3

In a different experiment where the furnace of the TGRU was kept at 900° C., the coking rate on a steel comparable to that in example 1 (e.g., 35 wt. % Cr 45 wt. % Ni) but without the spinel surface, and the coking rate was 5.194 mg/cm²h.

### Example 4

In a different experiment where the furnace of the TGRU was kept at 840° C., the coking rate on the spinel surface was 0.473 mg/cm²h.

The examples show that at temperatures below 900° C., or for example, below 850° C., the presence of the spinel surface on the stainless steel results in a very low coke rate.

What is claimed is:

1. In an apparatus for the production of pig iron in which hot reducing gas from the top of a blast furnace or a fluidized bed iron ore reduction reactor is cleaned of residual particulate matter and transferred through a transfer line to and upstream fluidized bed iron ore reduction reactor or pre-heater the improvement comprising forming the transfer line from a metal selected from the group consisting of carbon steel, stainless steel, heat resistant steel, HP, HT, HU, HW and HX stainless steel, and nickel or cobalt based HTA alloys having on its internal surface a coating having a thickness from 10 to 5,000 microns comprising from 40 to 60 weight % of compounds of the formula MnₓCr₃₋ₓO₄ wherein x is from 0.5 to 2 and from 60 to 40 weight % of oxides of Mn and Si selected from of MnO, MnSiO₃, Mn₂SiO₄ and mixtures thereof provided that the surface contains less than 5 weight % of Cr₂O₃.

2. The apparatus according to claim 1, wherein the hot reducing gas from the top of a blast furnace or a fluidized bed iron ore reduction reactor is cleaned of residual particulate matter using one or more separators selected from of a cyclone and a magnetic filter.

3. The apparatus according to claim 2, wherein not less than 85% of the inner surface of the transfer line is covered with said coating.

4. The apparatus according to claim 3, wherein said coating has a thickness from 10 to 1,000 microns.

5. The apparatus according to claim 4, wherein in said coating Cr₂O₃ is present in an amount of less than 2 weight %.

6. The apparatus according to claim 4, wherein the transfer line comprises from 13 to 50 weight % of Cr and from 20 to 50 weight % of Ni.

7. The apparatus according to claim 4, wherein the transfer line comprises from 50 to 70 weight % of Ni; from 20 to 10 weight % of Cr; from 20 to 10 weight % of Co; and from 5 to 9 weight % of Fe.

8. The apparatus according to claim 4, wherein the transfer line comprises from 40 to 65 weight % of Co; from 15 to 20 weight % of Cr; and from 20 to 13 weight % of Ni; less than 4 weight % of Fe; and up to 20 weight % of W.

9. The apparatus according to claim 6, wherein the oxide is MnO.

10. The apparatus according to claim 6, wherein the oxide is MnSiO₃.

11. The apparatus according to claim 6, wherein the oxide is Mn₂SiO₄.

12. The apparatus according to claim 6, wherein the oxide is a mixture of MnO, MnSiO₃ and Mn₂SiO₄.

13. The apparatus according to claim 7, wherein the oxide is MnO.

14. The apparatus according to claim 7, wherein the oxide is MnSiO₃.

15. The apparatus according to claim 7, wherein the oxide is Mn₂SiO₄.

16. The apparatus according to claim 7, wherein the oxide is selected from MnO, MnSiO₃, Mn₂SiO₄ and mixtures thereof.

17. The apparatus according to claim 8, wherein the oxide is MnO.

18. The apparatus according to claim 8, wherein the oxide is MnSiO₃.

19. The apparatus according to claim 8, wherein the oxide is Mn₂SiO₄.

20. The apparatus according to claim 8, wherein the oxide is a mixture of MnO, MnSiO₃ and Mn₂SiO₄.

21. In a process to reduce fine iron ores to sponge iron at a temperature from 700° C. to 900° C. and a pressure from 2 to 5 barg in the presence of a reducing gas in a series of two or more fluidized bed reactors wherein a reducing gas is passed from an upstream fluidized bed reactor to a downstream fluidized bed the improvement comprising removing particulate iron ore from the reducing gas prior to transfer to an upstream fluidized bed reactor and constructing the conduit for transferring said reducing gas relatively free of particulate iron ore of a metal selected from carbon steel, stainless steel, heat resistant steel, HP, HT, HU, HW and HX stainless steel, and nickel or cobalt based HTA alloys said conduit having on its internal surface a coating having a thickness from 10 to 5,000 microns comprising from 40 to 60 weight % of compounds of the formula MnₓCr₃₋ₓO₄ wherein x is from 0.5 to 2 and from 60 to 40 weight % of oxides of Mn and Si selected from of MnO, MnSiO₃, Mn₂SiO₄ and mixtures thereof provided that the surface contains less than 5 weight % of Cr₂O₃.

22. The process according to claim 21, the reducing gas comprises from 50 to 70 mole % of CO, from 30 to 15 mole % of H₂, from 10 to 5 mole % of CO₂, and from 0 to 10 mole % of N₂ the sum of said components adding up to 100 mole %.

23. The process according to claim 22, wherein the fine iron particles comprise at least 50 wt. % of one or more members selected from Fe, FeO, Fe₂0₃, and Fe₃0₄.
